(19) United States
(12) Patent Application Publication
(10) Pub. No.: US 2014/0166954 A1
(43) Pub. Date: Jun. 19, 2014

(54) COMPACT PORTABLE LIFTING APPARATUS

(71) Applicant: Richard W. Bogert, Kennewick, WA (US)

(72) Inventor: Richard W. Bogert, Kennewick, WA (US)

(21) Appl. No.: 14/035,153

(22) Filed: Sep. 24, 2013

Related U.S. Application Data
(60) Provisional application No. 61/704,768, filed on Sep. 24, 2012.

(51) Int. Cl. B66F 3/24

(52) U.S. Cl. CPC B66F 3/24
USPC 254/93 R

(57) ABSTRACT

A lifting apparatus operable to lift an object is provided. The lifting apparatus may include a base having a receiving recess and an actuatable cylinder movable between a collapsed configuration and a fully extended configuration to lift the object during a lifting operation. The actuable cylinder and the base may include, in some embodiments, recesses mounted therein to improve a stroke length to overall length ratio of the lifting apparatus.

### TECHNICAL FIELD

The present disclosure is directed to lifting devices, and more particularly, to compact, portable lifting devices suitable for lifting heavy loads.

### DESCRIPTION OF THE RELATED ART

In the field of lifting devices, such as hydraulic car jacks, conventional devices for lifting objects or loads may include bottle jacks, hydraulic rams, and the like. Such devices may be placed on ground surfaces, and a ram or an adapter may engage an object or load to be lifted. Using a leveraging mechanism via a lever or a handle, stroking may result in a hydraulic or other form of actuation to lift an object or load.

Conventional lifting devices may suffer from multiple drawbacks. For example, as these devices may be placed on varied surfaces, including sand and gravel, they often suffer from stability drawbacks due to relatively narrow bases. Additionally, sensitive actuation components such as hydraulic ports and couplings may need added protection. Furthermore, as these devices may be placed under the object or load to be lifted, the short operational strokes generally available may be restrictive to a point where these lifting devices may be unsatisfactory. Still further, conventional lifting devices, especially devices that may be used to lift heavy vehicles, may be bulky and heavy, thus making their transportation costly and less effective for many applications. Finally, as these conventional devices may require operators to be proximate to the object or load that is lifted, the lack of stability and proximate interaction may make operation particularly unsafe for operators.

### BRIEF SUMMARY

The lifting device apparatuses, systems, and methods of using the same described herein provide for safe, stable lifting of heavy loads. Moreover, according to some embodiments, lifting device apparatuses and systems are provided with an improved stroke length to overall length ratio.

According to one embodiment, a lifting device apparatus may be summarized as including: a base having a receiving recess; and an actuatable cylinder movable between a collapsed configuration and a fully extended configuration to lift the object during a lifting operation. The actuatable cylinder may be further summarized as including: a cylindrical barrel having a longitudinal bore extending therethrough and coupled to the base via the receiving recess of the base, the cylindrical barrel having an end cap recess; a piston mounted within the longitudinal bore of the cylindrical barrel and configured for reciprocal movement therein, the piston having a piston rod recess; a piston rod mounted within the longitudinal bore of the cylindrical barrel and coupled to the piston via the piston rod recess, the piston rod configured to extend from the cylindrical barrel as the actuatable cylinder moves toward the fully extended configuration; and an end cap mounted within the longitudinal bore of the cylindrical barrel and coupled to the cylindrical barrel via the end cap recess, the end cap configured to permit linear movement of the piston rod therethrough between the fully extended configuration and the collapsed configuration.

According to another embodiment, an actuating system for lifting a portion of an object may be summarized as including: an actuatable cylinder having a base with a lower surface and an extendable piston rod having an upper end; and a pressure source remotely coupled to the base of the actuatable cylinder via a conduit and in fluid communication therewith, the pressure source configured to move the piston rod of the actuatable cylinder to a fully extended configuration from a collapsed configuration, and wherein a distance between the lower surface of the base and the upper end of the extendable piston rod in the collapsed configuration defines an overall collapsed length of the actuatable cylinder, a difference between a distance between the lower surface of the base and the upper end of the extendable piston rod in the fully extended configuration and the overall collapsed length of the actuatable cylinder is a stroke length, and wherein a ratio of the stroke length to the overall collapsed length of the actuatable cylinder is at least 0.75.

### BRIEF DESCRIPTION OF THE SEVERAL VIEWS OF THE DRAWINGS

FIG. 1 is a perspective view of a system to lift a load L, showing a lifting apparatus, according to one embodiment, coupled to an auxiliary base and having a supplemental attachment at the point of engagement with the load L.

FIG. 2 is an enlarged perspective detail view of the system of FIG. 1.

FIG. 3 is an isometric view of the lifting apparatus of FIG. 1.

FIG. 4 is a cross-sectional isometric view of the lifting apparatus of FIG. 1 taken along line 4-4 in FIG. 3.

FIG. 5 is an enlarged cross-sectional detail view of the lifting apparatus of FIG. 1.

FIGS. 6a and 6b are front elevational views of the lifting apparatus of FIG. 1 shown in a fully extended and a collapsed configuration, respectively.

### DETAILED DESCRIPTION

In the following description, certain specific details are set forth in order to provide a thorough understanding of various disclosed embodiments. However, one of ordinary skill in the relevant art will recognize that embodiments may be practiced without one or more of these specific details. In other instances, well-known structures and devices associated with lifting devices, such as hydraulic jacks and the like, may not be shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is, as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

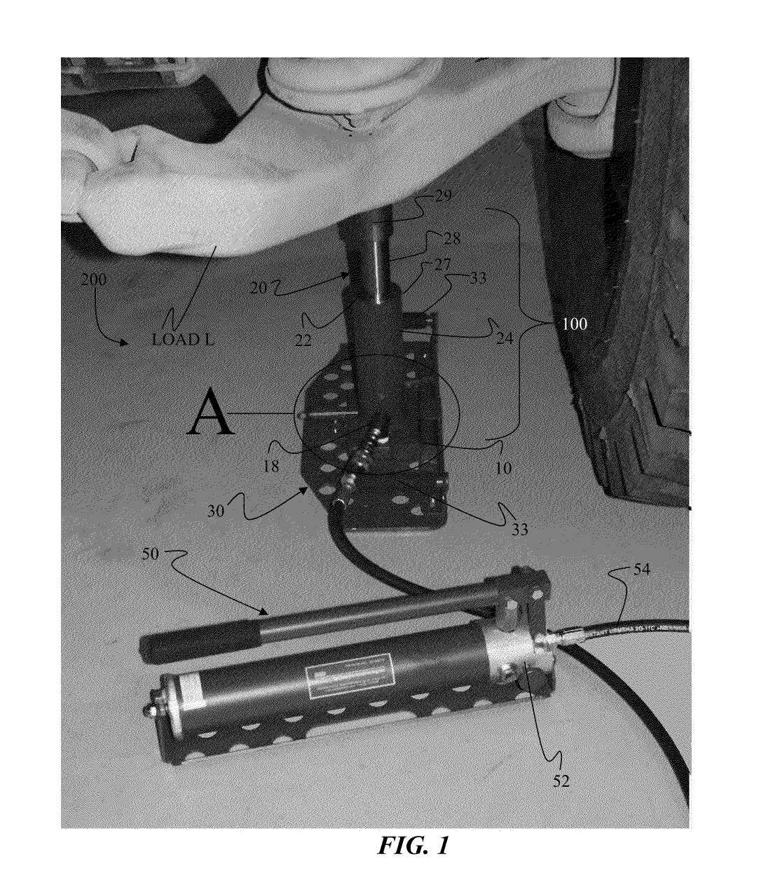

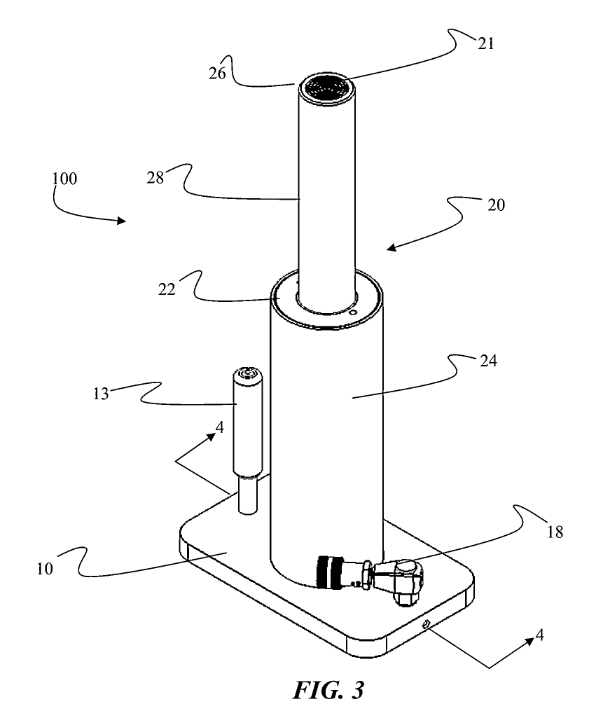

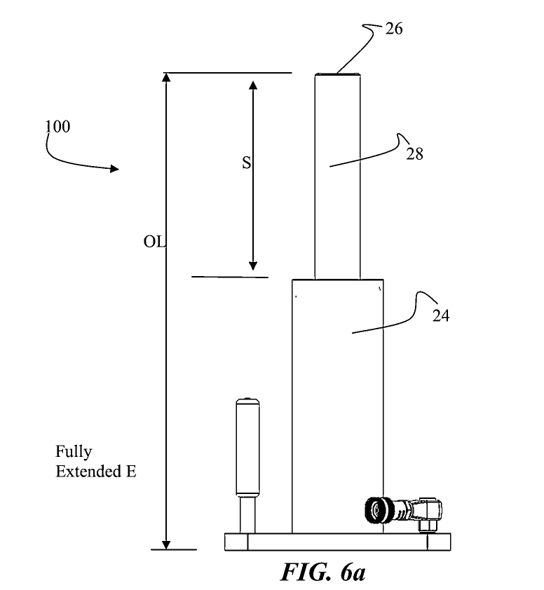

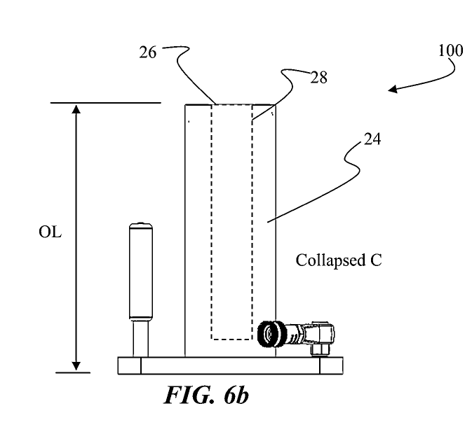

FIG. 1 shows a system 200 to lift a load L, according to one example embodiment. The system 200 may include a lifting apparatus 100, which is shown in a partially extended configuration lifting the load L, an auxiliary base 30 coupled to the lifting apparatus 100, and an external pressure source 50 coupled to the lifting apparatus 100. The lifting apparatus 100 may include an actuable cylinder 20 coupled to a base 10. The actuable cylinder 20 may include a cylindrical barrel 24 that has a longitudinal bore through which a piston rod 28 may reciprocate linearly. The cylindrical barrel 24 may be closed at an upper surface 27 by an end cap 22. The end cap 22 may have an opening through which the piston rod 28 may linearly extend. As the piston rod 28 may only travel through the opening of the end cap 22, upon reaching a fully extended configuration E (FIG. 6a), the end cap 22 may function as a stop, thus preventing over travel of the piston rod 28. Additionally, a supplemental attachment 29 may be coupled to a lifting or upper end 26 (FIG. 3) of the piston rod 28, such that the supplemental attachment 29 may engage a portion of the object or load L to be lifted during a lifting operation.

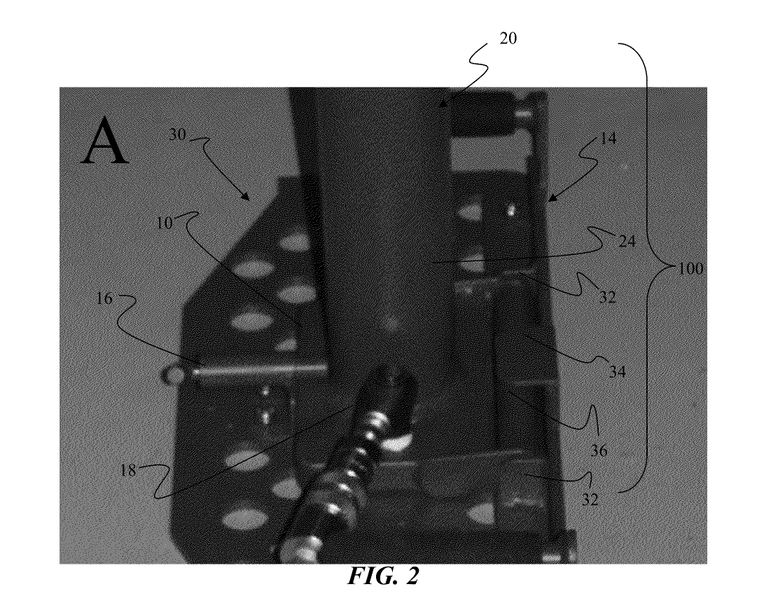

FIG. 2 shows an enlarged perspective detail view of the system 200 of FIG. 1. The actuable cylinder 20 may be coupled to the base 10 via welding the cylindrical barrel 24 to the base 10. The lifting apparatus 100 may be further coupled to an auxiliary base 30 via the base 10. More particularly, the auxiliary base 30 may include a mounting arrangement 14 that includes two vertical flanges 32 and a horizontal flange 34 to create a recess 36 such that the base 10 may slide within the recess 36. The vertical flanges 32 may restrict longitudinal movement of the base 10 and the horizontal flange 34 may restrict upward movement of the base 10. Additionally, the auxiliary base 30 may include a latch mechanism 16 to fixedly secure the lifting apparatus 100, such as a spring loaded pin. The latch mechanism 16 may be positioned at an opposing end of the lifting apparatus 100 with respect to the mounting arrangement 14, such that it may restrict lateral movement of the base 10. Additionally, the latch mechanism 16 may restrain an upper face of the base 10 to prevent the lifting apparatus 100 from separating from the auxiliary base 30. In other embodiments, the auxiliary base 30 may be coupled to the lifting apparatus 100 by threaded fasteners, or other fasteners.

With reference to FIGS. 1 and 2, one of ordinary skill in the relevant art will recognize that the ground engaging surface area of the auxiliary base 30 is larger than the surface area of the base 10. This additional surface area provided by the auxiliary base 30 may further distribute the load L to stabilize the lifting apparatus 100 and thus prevent sinking in soft surfaces, for example. Moreover, by preventing sinking, the auxiliary base 30 may consequently provide additional protection to hydraulic couplings, ports, or the like coupled to the base 10 by preventing damage that can be caused through contact with foreign debris of soft surfaces, such as sand or gravel.

With continued reference to FIGS. 1 and 2, handles 33 may be coupled to the auxiliary base 30 to assist in manipulating and positioning the lifting apparatus 100. In some instances, a handle 33 may be provided at or near each distal end of the auxiliary base 30. Such positioning of the handles 33 may stabilize the lifting apparatus 100 as the center of gravity may remain generally in the center of the lifting apparatus 100, thus aiding users with a relatively stable lifting apparatus 100 as it is carried around. In other embodiments, the length, positioning, or weight of the handle 33 may be adjusted to shift the center of gravity to the general center, as needed, to balance eccentricities in the lifting apparatus 100. For example, if relative to the center of the base 10, one half of the auxiliary base 30 or the base 10 has a different number of apertures than the other half of the auxiliary base 30 or the base 10, the center of gravity may shift accordingly. Thus, sizing each handle 33 by adjusting the length of the handle 33, for example, may accordingly shift the center of gravity of the lifting apparatus 100 such that it may remain in the general center of the lifting apparatus 100.

With continued reference to FIGS. 1 and 2, the lifting apparatus 100 may be coupled to an external pressure source 50. The external pressure source 50 may be a hand pump 52, which may be connected to the lifting apparatus 100 through a hydraulic port 18 coupled to the base 10. The conduit connecting the lifting apparatus 100 to the external pressure source 50 may be, for example, a hose 54. One of ordinary skill in the relevant art will recognize that, as the hand pump 52 is stroked, the actuable cylinder 20 is pressurized to extend the piston rod 28. The piston rod 28 may then engage a portion of an object or a load L and lift it vertically to a desired position. Embodiments may further include a release valve, which may aid in gradually descending the lifted object or load L back to the initial position.

FIG. 3 is an isometric view of the lifting apparatus 100 of FIG. 1. As shown in FIG. 3, the piston rod 28 of the lifting apparatus 100 may include a textured surface 21 machined at the lifting or upper end 26 of the piston rod 28. Having a textured surface 21 machined at the lifting or upper end 26 may improve gripping ability as the piston rod 28 engages the portion of the object or load L (FIG. 1) to be lifted. Moreover, in some embodiments, a ribbed cap or other engagement device may be threadedly coupled to the lifting or upper end 26 of the piston rod 28. The ribbed cap may, similar to the above described textured surface, improve gripping ability as the piston rod 28 engages the portion of the object or load L to be lifted. Additionally, in other embodiments, an extendable adjustment screw may be threadedly coupled to the lifting or upper end 26 of the piston rod 28. Having an extendable adjustment screw, when adjusted to extend outwardly relative to the lifting or upper end 26 of the piston rod 28, can increase the effective operating range of the lifting apparatus 100.

With reference to FIG. 3, a handle 13 to manipulate and position the lifting apparatus 100 may also be coupled to the base 10 itself in addition to or in lieu of handles 33 coupled to the auxiliary base 30 (FIGS. 1 and 2). The handle 13 may be positioned upright on the base 10 such that the center of gravity of the lifting apparatus 100 is below a lifting point of the handle 13, where a user may grip the handle 13. Such positioning of the handle 13 can enable users to carry the lifting apparatus 100 in a stable manner. In other embodiments, a handle 13 may be coupled to the cylindrical barrel 24 and, at a position, where the center of gravity of the lifting apparatus 100 remains below the lifting point of the handle 13.

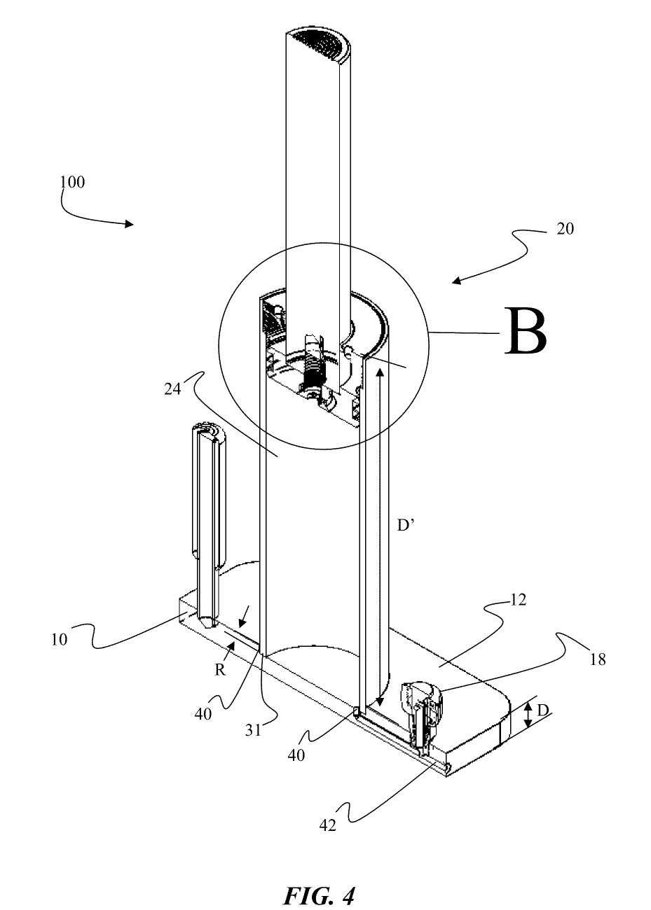

FIG. 4 shows a cross-sectional view of the lifting apparatus 100 of FIG. 1. The base 10 may include a receiving recess 40 that is tapped, through which a lower surface 31 of the cylindrical barrel 24 may be threadedly coupled to the base 10. In other embodiments, the cylindrical barrel 24 may be mounted within the receiving recess 40 and welded to the base 10 (FIGS. 1 and 2). The receiving recess 40 may have a recess depth (R) relative to an upper surface 12 of the base 10 and, accordingly, a recess (R) to depth (D) ratio. The recess depth (R), according to one embodiment, may be 0.25 inch and the recess (R) to depth (D) ratio may be about 0.33. In other embodiments, the recess depth (R) may be in the range of 0.25 inch to 0.5 inch and the recess (R) to depth (D) ratio may be in the range of 0.33 to 0.5. Further yet, in other embodiments, the receiving recess 40 may still be deeper or shallower, accordingly adjusting the recess (R) to depth (D) ratio, depending on requirements. Having a receiving recess 40, moreover, can improve the stroke length S (FIG. 6a) to overall length OL (FIGS. 6a and 6b) ratio, as the receiving recess 40 may contribute to reducing the overall length OL (FIGS. 6a and 6b) of the lifting apparatus 100.

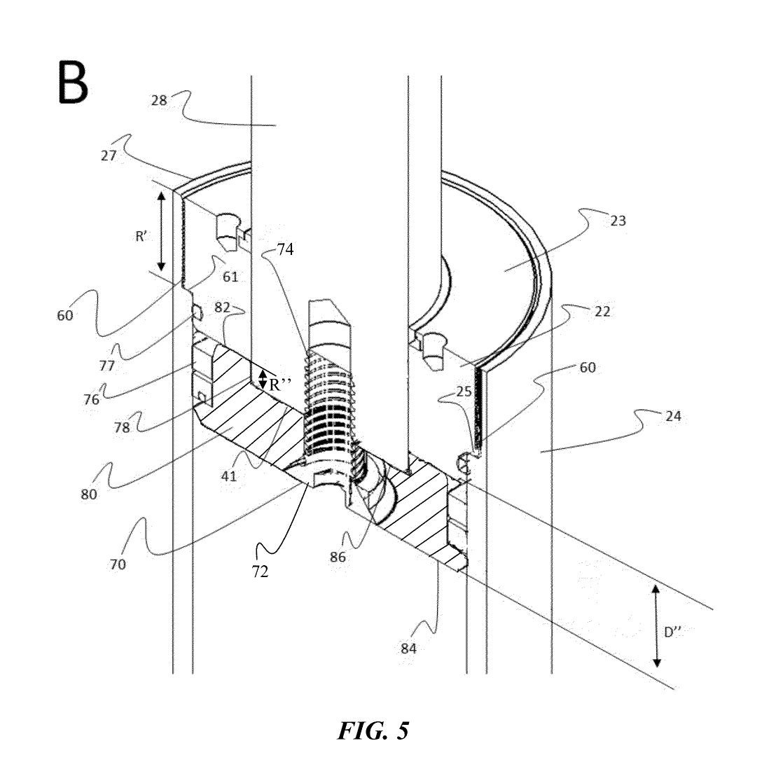

With reference to FIG. 4, the base 10 may also include an internal fluid passageway 42 leading to the cylindrical barrel 24 of the actuable cylinder 20 that may connect the external pressure source 50 (FIGS. 1 and 2) to the lifting apparatus 100 through the hydraulic fitting 18. In other embodiments, a hydraulic fitting or adapter may be coupled directly to the cylindrical barrel 24 in lieu of the internal fluid passageway 42. Having this internal fluid passageway 42 in the base 10, however, can advantageously provide a greater stroke length S (FIG. 6a) to overall length OL (FIGS. 6a and 6b) ratio because a piston 80 (FIG. 5) may now fully retract in the collapsed configuration C (FIG. 6b). Retracting the piston 80 fully in the collapsed configuration C (FIG. 6b) can reduce the overall length OL (FIGS. 6a and 6b) of the lifting apparatus 100, rather than lose any potential retractable length to accommodate routing of hydraulic fluid to the cylindrical barrel 24.

FIG. 5 shows an enlarged partial cross-sectional detail view of the lifting apparatus 100 of FIG. 1. As shown in FIG. 5, the cylindrical barrel 24 may include an end cap recess 60 that is tapped, through which the end cap 22 may be threadedly coupled to the cylindrical barrel 24. In some embodiments, the end cap 22 may be mounted within the end cap recess 60 and welded to the cylindrical barrel 24. The end cap recess 60 may have a recess depth (R′) relative to an upper surface 27 of the cylindrical barrel 24 and, accordingly, a recess (R′) to depth ((D′) FIG. 4) ratio. The recess depth (R′), according to one embodiment, may be 1 inch and the recess (R′) to depth (D′) ratio may be about 0.09. In other embodiments, the recess depth (R′) may be in the range of 1 inch to 2 inch and the recess (R′) to depth (D′) ratio may be in the range of about 0.09 to 0.2. Further yet, in other embodiments, the end cap recess 60 may still be deeper or shallower, accordingly adjusting the recess (R′) to depth (D′) ratio, depending on requirements.

With reference to FIG. 5, coupling the end cap 22 to the cylindrical barrel 24 through the end cap recess 60 can increase the strength of the connection by providing a rigid shoulder 61 at an end of the connection, upon which a lower surface 25 of the end cap 22 may rest. The end cap 22 may also include an o-ring 77 or other seal devices to sealingly engage the end cap 22 with the cylindrical barrel 24.

With continued reference to FIG. 5, the piston 80, which facilitates the reciprocating movement, may include a piston rod recess 78 at an upper surface 82 of the piston 80 within which the piston rod 28 may be mounted. The piston rod recess 78 can improve the strength of the connection between the piston 80 and the piston rod 28 by providing a rigid shoulder 86 at an end of the connection, upon which a lower surface 41 of the piston rod 28 may rest. The piston rod recess 78 may have a recess depth (R″) relative to an upper surface of the piston 80 and, accordingly, a recess (R″) to depth (D″) ratio. The recess depth (R″), according to one embodiment, may be 0.25 inch and the recess (R″) to depth (D″) ratio may be about 0.25. In other embodiments, the recess depth (R″) may be in the range of 0.25 inch to 0.5 inch and the recess (R″) to depth (D″) ratio may be in the range of about 0.25 to 0.5. Further yet, in other embodiments, the piston rod recess 78 may still be deeper or shallower, accordingly adjusting the recess (R″) to depth (D″) ratio, depending on requirements.

With continued reference to FIG. 5, a lower surface 84 of the piston 80 may include an attachment recess 70. The attachment recess 70 may be configured to receive a countersunk fastener 72. The piston rod 28, meanwhile, may have a tapped hole 74 to facilitate coupling the piston 80 to the piston rod 28 via the countersunk fastener 72. In other embodiments, other methods, such as use of a counterbore, may be used to provide an attachment recess 70 for coupling the piston rod 28 to the piston 80. Additionally, the piston 80 may include o-rings 76, metallic rings, such as piston rings, or other seal devices to sealingly engage the piston 80 to the cylindrical barrel 24.

With continued reference to FIG. 5, the piston rod recess 78 and the end cap recess 60 can increase the stroke length S (FIG. 6a) of the piston rod 28 with respect to the overall length OL (FIGS. 6a and 6b) of the lifting apparatus 100, as the piston rod 28 now may have more travel length. Additionally, because the outer diameter of the piston rod 28 may be less than the inner diameter of the end cap 22 opening, the piston rod 28 may fully retract within the cylindrical barrel 24 such that in the fully collapsed configuration C (FIG. 6b), the piston rod 28 lifting or upper end 26 may sit flush or about flush with the end cap 22 upper surface 23 (FIG. 6b). Moreover, as the piston rod 28 may be coupled to the piston 80 via a countersunk fastener 72, where the fastener head sits flush with or below the lower surface 84 of the piston 80, accordingly the piston 80 may fully retract in the collapsed configuration C (FIG. 6b). As the piston 80 fully retracts, the lower surface 84 of the piston 80 may sit flush with the lower surface 31 (FIG. 4) of the cylindrical barrel 24, thus reducing the overall length OL (FIGS. 6a and 6b) of the lifting apparatus 100 in the collapsed configuration C (FIG. 6b).

FIGS. 6a and 6b show the lifting apparatus 100 of FIG. 1 in a fully extended configuration E and a collapsed configuration C, respectively. The stroke length S of the lifting apparatus 100 corresponds to the total travel of the piston rod 28. It may be calculated as a difference between the overall length OL of the lifting apparatus 100 in the fully extended configuration E and the overall length OL of the lifting apparatus 100 in the collapsed configuration C. Accordingly, a stroke length S to overall length OL in the collapsed configuration C ratio of the lifting apparatus 100 may be calculated. Some of the embodiments, for example, may include the following:

| Overall Length | Overall Length | Stroke | Stroke length to |
|---|---|---|---|
| OL (Extended E) | OL (Collapsed C) | Length S | overall length ratio |
| 16.375 | 9.0 | 7.375 | 0.82 |
| 21.125 | 12.0 | 9.125 | 0.76 |
| 23.125 | 13.0 | 10.125 | 0.78 |

As can be appreciated by one of ordinary skill in the relevant art, the above described stroke length to overall length ratios may have been possible due at least in part to one or more of the recesses 40, 60, 70, 78 and other features described above, such as contracting the piston rod 28 until the lifting or upper end 26 of the piston rod 28 sits flush or about flush with the upper surface 23 of the end cap 22.

Although embodiments of the lifting apparatuses 100 described and shown herein may increase the stroke length collectively via the recesses 40, 60, 70, and 78, in other embodiments a recess may only be provided in one component, such as the base 10 only, or in other embodiments, a recess may only be provided in the piston 80 and the cylindrical barrel 24. Additionally, while the embodiments shown and described herein obtain a stroke length S to overall length OL ratio in the range of about 0.75 to about 0.83 via recesses and other features, in other embodiments a combination of reduced thicknesses of features, for example, end cap 22 thickness, may be combined with other features to improve the stroke length S to overall length OL ratios even further.

Moreover, the various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A lifting apparatus operable to lift an object, the lifting apparatus comprising:
a base having a receiving recess; and
an actuatable cylinder movable between a collapsed configuration and a fully extended configuration to lift the object during a lifting operation, the actuatable cylinder including:
a cylindrical barrel having a longitudinal bore extending therethrough and coupled to the base via the receiving recess of the base, the cylindrical barrel having an end cap recess;
a piston mounted within the longitudinal bore of the cylindrical barrel and configured for reciprocal movement therein, the piston having a piston rod recess;
a piston rod mounted within the longitudinal bore of the cylindrical barrel and coupled to the piston via the piston rod recess, the piston rod configured to extend from the cylindrical barrel as the actuatable cylinder moves toward the fully extended configuration; and
an end cap mounted within the longitudinal bore of the cylindrical barrel and coupled to the cylindrical barrel via the end cap recess, the end cap configured to permit linear movement of the piston rod therethrough between the fully extended configuration and the collapsed configuration.

2. The lifting apparatus of claim 1 wherein a ratio of a stroke length of the lifting apparatus between the collapsed configuration and the fully extended configuration to an overall length of the lifting apparatus in the collapsed configuration is at least 0.76.

3. The lifting apparatus of claim 1 wherein the cylindrical barrel is threadedly coupled to the base within the receiving recess such that the cylindrical barrel extends at least 0.25 inches below an upper surface of the base.

4. The lifting apparatus of claim 1 wherein the cylindrical barrel is welded within the receiving recess of the base such that the cylindrical barrel extends at least 0.25 inches below an upper surface of the base.

5. The lifting apparatus of claim 1 wherein a receiving recess to depth of the base ratio is about 0.33.

6. The lifting apparatus of claim 1 wherein the end cap is threadably coupled to the cylindrical barrel within the end cap recess such that the end cap extends at least 1 inch below an upper surface of the cylindrical barrel.

7. The lifting apparatus of claim 1 wherein an end cap recess to depth of the cylindrical barrel ratio is about 0.09.

8. The lifting apparatus of claim 1 wherein the base includes a handle coupled thereto to allow a user to manipulate and position the lifting apparatus.

9. The lifting apparatus of claim 8 wherein the handle is positioned on the base relative to a center of gravity of the lifting apparatus to stabilize the lifting apparatus when the lifting apparatus is carried by a user.

10. The lifting apparatus of claim 1 wherein the base includes a fluid passageway extending through a portion thereof to allow fluid communication between the actuable cylinder and a pressure source coupled thereto.

11. The lifting apparatus of claim 10 wherein the pressure source is a hand pump.

12. The lifting apparatus of claim 1, further comprising:
an auxiliary base having a ground engaging surface area that is greater than a base surface area of the base of the lifting apparatus, and wherein the base of the lifting apparatus is removably coupleable to the auxiliary base to enhance stability of the lifting apparatus.

13. The lifting apparatus of claim 12 wherein the auxiliary base includes a latch mechanism to removably couple the base of the lifting apparatus to the auxiliary base.

14. The lifting apparatus of claim 12 wherein the latch mechanism includes a spring loaded pin to fixedly secure the lifting apparatus.

15. The lifting apparatus of claim 1, further comprising:
at least a handle that is positioned on the base relative to a center of gravity of the lifting apparatus to stabilize the lifting apparatus when the lifting apparatus is carried by a user.

16. The lifting apparatus of claim 1 wherein the piston rod includes a textured surface machined on a lifting end of the piston rod to improve gripping ability of the piston rod.

17. The lifting apparatus of claim 1, further comprising:
a ribbed cap having a textured surface coupled to a lifting end of the piston rod to improve gripping ability of the piston rod.

18. The lifting apparatus of claim 1, further comprising:
an extendable adjustment screw threadedly coupled to a lifting end of the piston rod.

19. The lifting apparatus of claim 1 wherein the cylindrical barrel includes a lower surface and an upper surface, the upper surface including an end cap recess portion, the lower surface coupling to the base via the receiving recess;
the piston includes an upper surface and a lower surface, the upper surface having the piston rod recess portion, the lower surface having an attachment recess portion configured to receive a coupling device such that the coupling device is about flush with the lower surface of the piston or inset within the piston;
the piston rod mounted within the piston rod recess portion of the piston includes an upper end and a lower surface, the lower surface coupled to the piston at the attachment recess portion via the coupling device; and
the end cap includes a lower surface, the lower surface coupled to the cylindrical barrel end cap recess portion, and wherein
the end cap recess portion, the piston rod recess portion, the attachment recess portion, and the receiving recess cooperate to increase a stroke length of the lifting apparatus between the collapsed configuration and the fully extended configuration with respect to an overall length of the lifting apparatus in the collapsed configuration.

20. The lifting apparatus of claim 19 wherein the piston rod mounted within the piston rod recess of the piston extends at least 0.25 inch below the upper surface of the piston.

21. The lifting apparatus of claim 19 wherein a piston rod recess to depth of the piston ratio is about 0.25.

22. The lifting apparatus of claim 19 wherein the attachment recess portion is configured to receive a countersunk fastener such that a countersunk fastener head is about flush with the lower surface of the piston or inset within the piston.

23. The lifting apparatus of claim 19 wherein the piston rod is coupled to the piston via a countersunk fastener.

24. The lifting apparatus of claim 19 wherein, in the collapsed configuration, the piston rod upper end extends inwards with respect to an upper surface of the end cap, and wherein, in the fully extended configuration, the end cap lower surface limits linear extension of the piston rod.

25. An actuating system for lifting a portion of an object, the system comprising:
an actuatable cylinder having a base with a lower surface and an extendable piston rod having an upper end; and
a pressure source remotely coupled to the base of the actuatable cylinder via a conduit and in fluid communication therewith, the pressure source configured to move the piston rod of the actuatable cylinder to a fully extended configuration from a collapsed configuration, and wherein
a distance between the lower surface of the base and the upper end of the extendable piston rod in the collapsed configuration defines an overall collapsed length of the actuatable cylinder,
a difference between a distance between the lower surface of the base and the upper end of the extendable piston rod in the fully extended configuration and the overall collapsed length of the actuatable cylinder is a stroke length, and wherein
a ratio of the stroke length to the overall collapsed length of the actuatable cylinder is at least 0.75.
